(19) United States
(12) Patent Application Publication
(10) Pub. No.: US 2006/0167725 A1
(43) Pub. Date: Jul. 27, 2006

(54) Method and apparatus for scheduling

(75) Inventors: Dan Grunspan, Bellevue, WA (US); Graham Andrew Michael Sheldon, Seattle, WA (US); Michael J. Ott, Redmond, WA (US); Naveen Garg, Seattle, WA (US); Ilya Baimetov, Redmond, WA (US); Tsvi Reiter, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/042,423

(22) Filed: Jan. 25, 2005

(51) Int. Cl. G06Q 10/00

(52) U.S. Cl. 705/5

(57) ABSTRACT

A method and apparatus for scheduling is disclosed. The method may include g a service for which a scheduling strategy is to be applied, selecting the scheduling to be applied to the service selected, selecting an action to be applied to the selected accessing a calendar related to the selected service, in view of the service selected, g the constraints to be applied as required by the scheduling strategy and returning a applying the constraints.

### BACKGROUND

Numerous constraints such as time, cost and availability have long kept businesses and people from maximizing the use of resources. Computers have been helpful in keeping track of availability and recent developments have allowed for the sharing of calendar information. However, as processes have become more complex, including complex rules of availability for resources and conflicting demands on resources, the ability to track and optimize schedules has not kept up.

### SUMMARY

A method and apparatus for scheduling critical resources is disclosed. The method may include selecting a service for which a scheduling strategy is to be applied, selecting the scheduling strategy to be applied to the service selected, selecting an action to be applied to the selected service, accessing a calendar related to the selected service, in view of the service selected, allowing the constraints to be applied as required by the scheduling strategy and returning a result of applying the constraints. The actions may include search, verify, book, query, reschedule and cancel. The scheduling strategy or methodology may also include allowing constraints and objective functions to be interpreted differently based on the service selected and/or the scheduling strategy selected. The scheduling strategy or methodology may also allow a weight to be applied to the function to be optimized when there are a plurality of weights and selecting a calendar related to the at least one selected resource. A computer system with a processor to execute instructions and a computer readable medium with computer instructions are disclosed to execute the method.

### DRAWINGS

FIG. 1 is a block diagram of a computing system that may operate in accordance with the claims;

FIG. 2 is flow chart of a method in accordance with the claims;

FIG. 3 is a block diagram of the modules of a method in accordance with the claims;

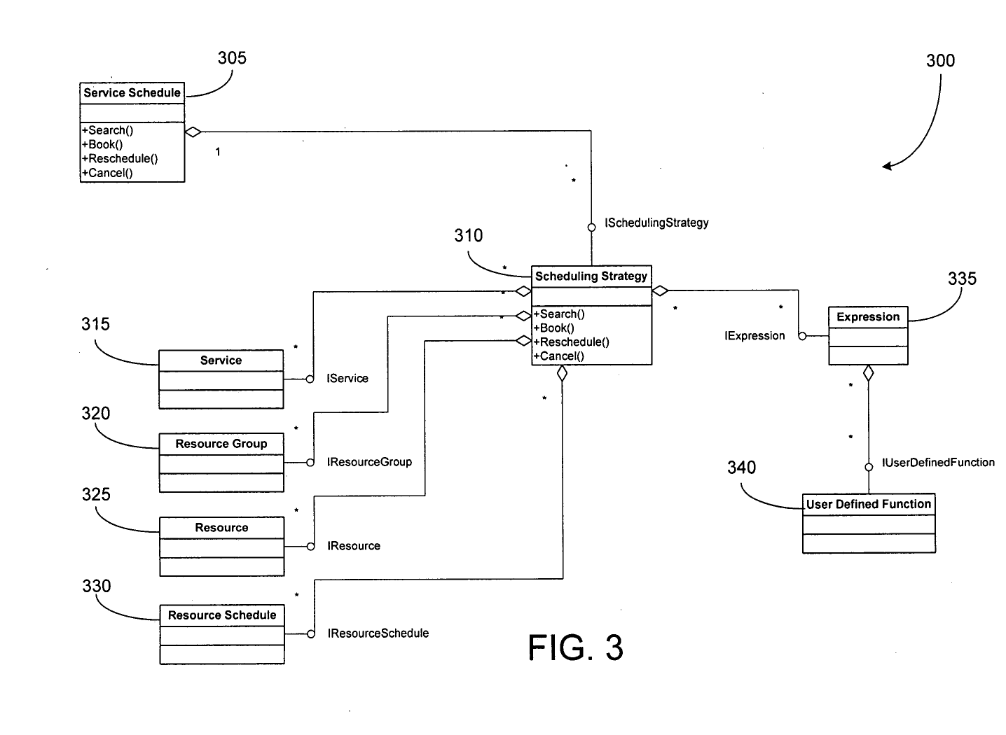

FIG. 4 is an illustration of a display of a scheduling interface in accordance with the claims;

FIG. 5 is an illustration of a display of a required resource selection interface in accordance with the claims;

FIG. 6 is an illustration of a selection rule edit display in accordance with the invention;

FIG. 7 is an illustration of a schedule search activity display in accordance with the claims;

FIG. 8 is an illustration of a search result from a search of FIG. 5 in accordance with the claims; and

FIG. 9 is an illustration of an appointment display in accordance with the claims.

### DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

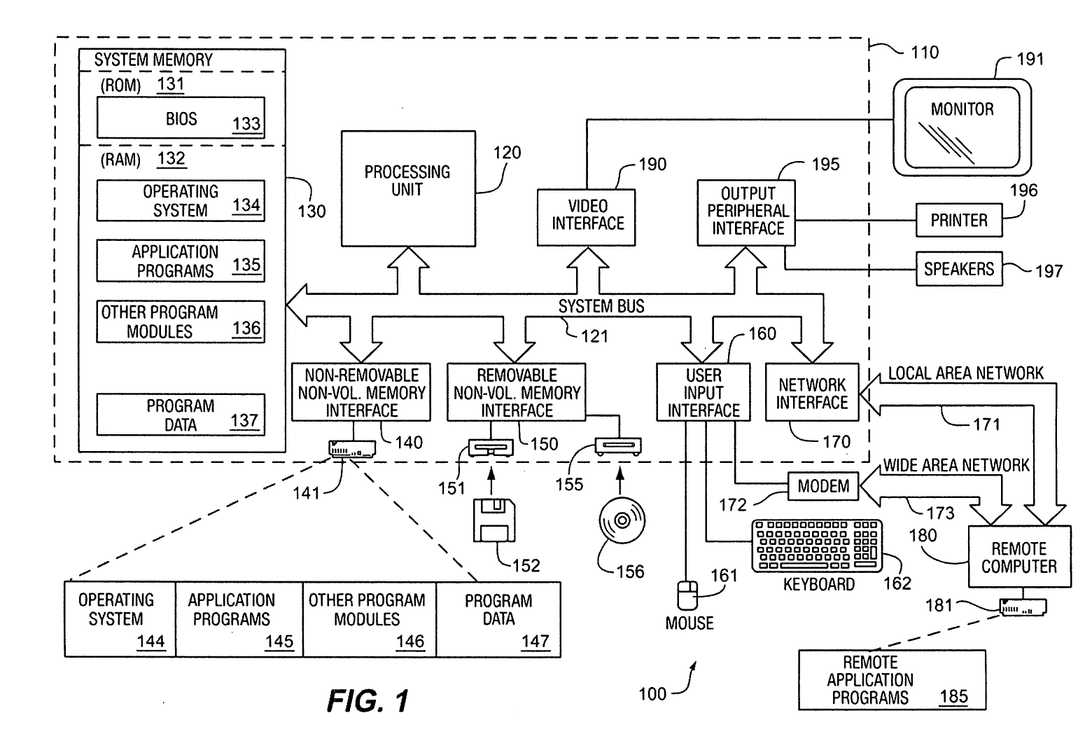

FIG. 1 illustrates an example of a suitable computing system environment 100 on which a system for the steps of the claimed method and apparatus may be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

The steps of the claimed method and apparatus are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The steps of the claimed method and apparatus may be described in the general context of computer-executable instructions, such as program modules, being executed by a computer. Generally, program modules include routines, programs, objects, components, data structures, etc. that perform particular tasks or implement particular abstract data types. The methods and apparatus may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the steps of the claimed method and apparatus includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

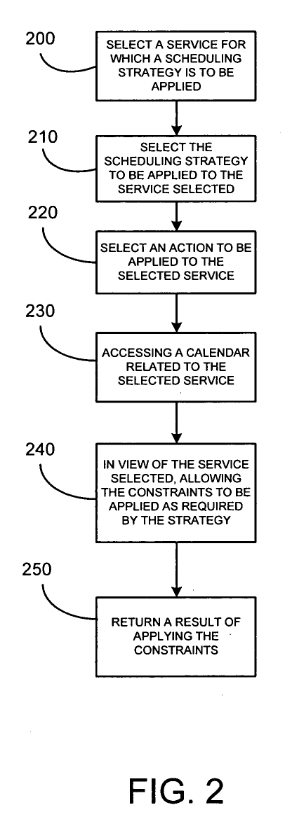

FIG. 2 may illustrate a method of scheduling in accordance with the teachings of the claims. At block 200, the method may provide for selecting a service for which a scheduling strategy is to be applied. Services that need to be scheduled in accordance with the teachings of the method may be found in health care, trade services, construction services, financial services, legal services, etc. Some examples of services may include surgery, cable repair, plumbing inspection, tax preparation, and patent preparation.

A scheduling strategy may be an algorithm or set of procedures that operates on a collection of constraints to guide an action. Constraints may be further described as being qualification rules or availability rules. Qualification rules may ensure that only resources that meet one or more criterion will be selected. Qualification rules may specify that a resource must have a certain set of skills or proficiencies. Qualification rules may also specify that a resource must belong to a predetermined list of resources. Qualification rules may also specify that a team of resources are required to perform a service. Availability rules may require that the resources have time or capacity available. The most frequent constraint may specify that the resource is not already busy. An availability constraint may also specify that no more than X instances of service are performed in a given day by any resource. Another availability constraint may specify that a service cannot be scheduled without at least five days lead time. Finally, an availability constraint may specify that a resource may not perform more than X resources over a given period of time. By first using qualification rules, the pool of resources may be quickly reduced and availability rules may be applied to the qualified resources.

Additional constraints may include functions that may be optimized by the scheduling strategy. Examples of functions to be optimized include resource utilization, cost, distance, and random. When the scheduling strategy evaluates these functions, it may yield a result that is least busy, least costly, closest to a certain location, or random. For example, if a user specifies that the scheduling strategy should minimize utilization, the result may be that resources are utilized evenly over a period of time. Unlike qualification rules and availability rules, functions to be optimized do not necessarily have to be satisfied and may be interpreted differently by the scheduling strategy that is chosen. The algorithm or set of procedures that comprise a strategy may attempt to optimize a function.

The method may allow for multiple functions to be optimized to be specified for the service. The functions to be optimized may then be given different weights or priorities as determined by the scheduling strategy. For example, a scheduling strategy may give a 75% weight to the cost function to be minimized and a 25% weight on the speed function to be maximized. The method may also allow for multiple objectives to be combined within a single function to be optimized. For example, the function to be optimized may explicitly specify that a 50% weight be used as the multiplier for the objective to minimize cost and a 50% weight be used as the multiplier on the objective to maximize speed.

At block 210, the method may provide for selecting the scheduling strategy to be applied to the service selected. A variety of scheduling strategies may be used. For example, consider a service with a duration of four hours. One scheduling strategy might assume that the resource selected must have continuous availability. Another strategy might not make the same assumption. Suppose that a resource works from 9 am to 5 pm with a one hour lunch break at 12 pm. The first strategy would not return 9 am as a valid search result because 9 am-1 pm is not continuously available. The second strategy would indeed return 9 am as a valid search result because it would append assume that the result included both 9 am-12 pm and 1 pm-2 pm.

Another potential difference between strategies is the interpretation of a mandatory resource. One of the constraints that the calling user may introduce is a requirement that a resource must be included in the valid result. If the resource is qualified to perform the service in more than one role and has the availability to do so, different scheduling strategies may decide to satisfy the constraint by choosing that resource in different roles.

A service provider may maintain a set of constraints and write their own scheduling strategy to obtain the scheduling behavior that best suits the services they provide. That is, an existing service and the constraints may be left as is and a brand new scheduling strategy may be put into use. Further, the constraints may be interpreted differently by different scheduling strategies. For example, a constraint may be that all the cable installation supplies be obtained from the same location. In a first scheduling strategy, the “same location” may be interpreted as being the exact same physical address. In a second scheduling strategy, the “same location” may be interpreted as being the same city. As a result, the same constraint (all supplies from the same location) can be easily added to different scheduling strategies but the constraint may be interpreted different by the various scheduling strategies.

The method may also allow a user to add constraints to an action. For example, there may be a constraint that all doctors for a service come from the same site or location. A user may add a constraint that the location must be in Chicago and the action may be repeated. The user may then change the constraint to be that the location must be the Chicago metro area or even an entirely different city, such as Seattle, and the action may be repeated again. In this way, a user may be permitted to do a sort of “what if” query by changing a user constraint.

At block 220, the method may provide for selecting an action to be applied to the selected service. Actions may include search, verify, book, cancel, reschedule and query. Certainly, other actions are possible.

Search may return results that satisfy the constraints and the function to be optimized. For example, if a truck is needed to install cable at a residence, the times and combinations of resources including a truck that is available may be returned.

Verify may check to ensure that an existing appointment (time and resource combination) are still valid. For example, if a previous search has determined that a truck is available on Wednesday between 10 am and 11 am, verify may check to ensure that a truck is still available between 10 am and 11 am and that the truck is still qualified.

Book may reserve one or more resources for one or more time periods. Book may ensure that while it is marking the time block as unavailable that no other user is invoking another action and obtaining false results. As in the previous example, the resulting time block of 10 am to 11 am would be marked as unavailable for the truck. When the user is booking this time, no other user will see that time block as available.

Reschedule may be used to update and/or discover a new time. By using re-schedule, the constraints used to locate the original time will be used to locate a new time. Re-schedule may use the search function to search for available time while ignoring the appointment that is to be rescheduled and then updating the appointment to the new time. For example, if appointment A is scheduled at 1:00 pm on Monday and a user selects to reschedule appointment A, 1:00 pm on Monday will appear as open or available for the appointment to be rescheduled. Appointment A then can be updated to be scheduled at a new time, overlapping the previously scheduled time.

Cancel may remove an appointment. Cancel may be subject to rules or constraints which may be part of the scheduling strategy. For example, there may be a rule or constraint for the service that specifies that an appointment cannot be cancelled without two weeks notice.

Query may return all the information for a given entity for a given period of time without regard to rules or constraints. The results of query may be a raw listing of when a resource is available during a given time period. When a resource is free can be extrapolated from this information in a manual, “browse-like” fashion.

In addition, the method may provide additional information on why a particular time is not available. For example, if there is a scheduling conflict, the method may provide information regarding the specific conflict. Another example may be that a resource does not have sufficient capacity and the method may provide this information. Instead of merely providing a “null” response, the method may provide specifics regarding the conflict. The user may then be able to modify the conflicting event.

In yet a further example, a scheduling strategy may interpret certain types of service as having higher priority than others. For example, a personal appointment may have a lower priority than a meeting with an important client. When the scheduling strategy attempts to book the important meeting that conflicts with a haircut, the scheduling strategy may present the user with options to reschedule the haircut or it may reschedule the haircut for a different time automatically. Other behaviors may be possible.

At block 230, the method may provide for accessing a calendar related to the selected service. Each service may have a calendar specifying when to use particular constraints. For example, using the cable installation example, installation technicians may be required and this constraint may be part of the cable installation calendar and the method may respect such a requirement.

At block 240, the method may provide for allowing the constraints to be applied as required by the scheduling strategy in view of the service selected. For example, if the scheduling strategy is to install cable television, a first constraint may be that a cable installation technician may be required. The method may then search to locate the qualified technicians and may further proceed by examining which the qualified technicians have available time.

At block 250, the method may provide for returning a result of applying the constraints. In the cable installation example, the scheduling strategy may return a qualified resource and time when he or she can perform the installation when the search action is invoked.

The method may include selecting at least one resource related to the service selected. Resources may be physical objects, facilities, equipment, tools, people or teams that may be involved in providing a service. When choosing one or more resources, the service may specify that those resources must come from a resource group. Resource groups may be a collection of resources with similar properties, qualities, qualifications, skills or proficiencies. In the cable installation example, the service may require resources from the following resource groups: trucks, ladders, cable jacks, technicians, senior technicians, installers, etc. Teams may be resources that are typically paired together such as a doctor that works with a particular anesthesiologist.

In addition, the functions to be optimized do not have to be linear functions. For example, a function may have various price breaks based on the volume of purchases such as $1 per unit for 0-10 units, $0.90 per unit for 51-50 units and $0.75 per unit for 51-200 units. A user may be able to enter such a non-linear function and the method may be able to optimize the non-linear function. In one example, the method may use constraints to limit the possible permutations and the scheduling strategy may evaluate those permutations to arrive at the optimal result.

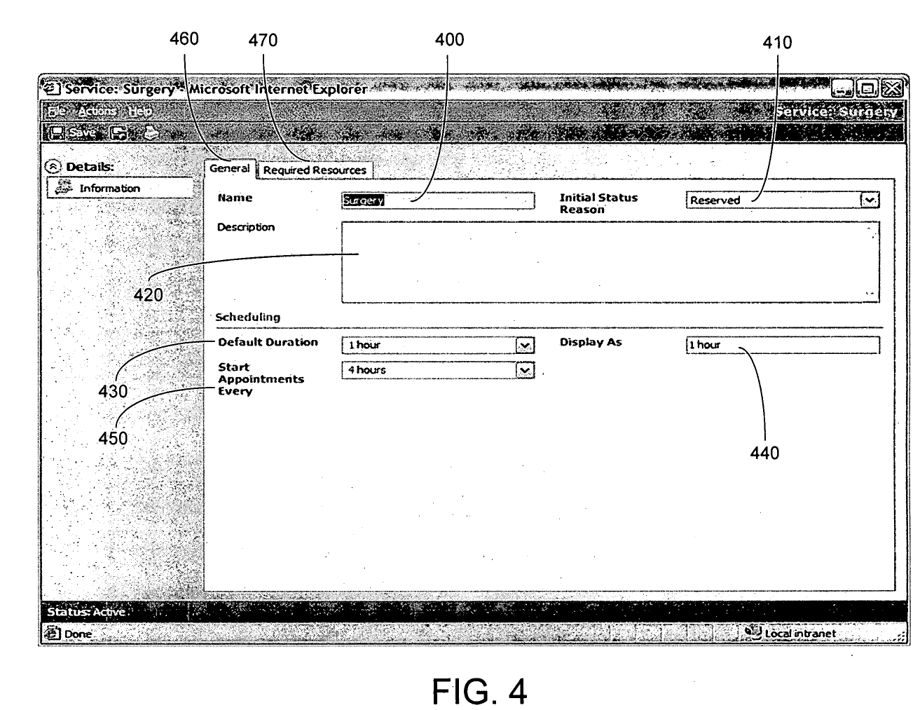

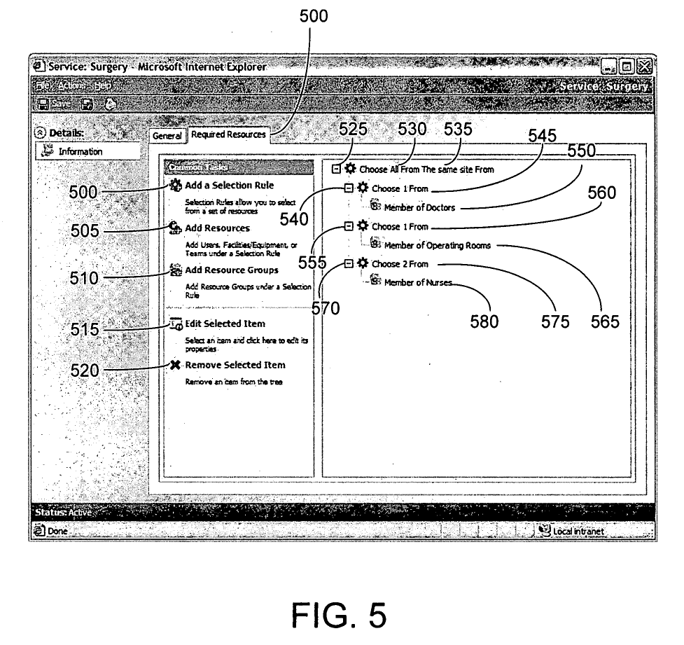

FIG. 4 may be a further example of applying the method. In FIG. 4, the service that may be selected may be entered into a field 400 which may be a drop down box or an input field. In this example, surgery may be the selected service. The initial status reason may be selectable by using a field 410 which may be a drop down box or an input field. In this case, the time in the resources calendars will be indicated as being “Reserved” and certainly, other options are possible. A description field 420 may be provided where additional information about the particular scheduled service may be added. A default duration for the service may be indicated 430 and this duration may be adjustable by selecting a drop down box or by inputting a value into the duration field 430. Even though the duration of the service has been inputted in field 430, a separate duration may be inputted in an input box 440 to allow a different duration to be displayed on a resources calendar. For example, a certain service may require fifteen minutes of prep time and fifteen minutes of clean up time, and it may be desirable to indicate that the total time for the service be displayed as 1 hour and 30 minutes (one hour service plus 15 minutes of set-up plus fifteen minutes of clean up). Another input box may allow for the input of a “start appointments every” time period 450. In this example, the “start appointments every” time period 450 is indicated as being four hours. Even though a service may take only an hour, prep and clean-up time may be involved and the actual service may be taxing on the resources and the resources may require time to regroup and recharge between services. Another selection option that is not illustrated may allow for the selection of a scheduling strategy for each service selected. Once the general parameters of a service are entered 460, selecting a “required resources” tab 470 may result in a display such as in FIG. 5.

FIG. 5 may be an illustration of a display of the selection of required resources 500. The user interface may present options for adding a selection rule or constraint to a service search 502, adding resources to a service search 505, adding resource groups to a service search 510, editing items selected 515 and removing items selected 520. In the example of FIG. 4, several selection rules and related resource may be displayed.

A first rule 525 may indicate that the method should CHOOSE “all” 530 the resources (the selection rule) FROM 435 “the same site” (the resource or resource group). The selection rule 535 may be selected using the “Add Selection Rule” option 502 and the resource or resource group may be added using the options “Add Resource” 505 or “Add Resource Groups” 510. The rule may allow other options for the selection rule 535 such as CHOOSE “at least one” or “none” or “as many as possible” or any number such as “one” or “two” Or “one or more.” Similarly, numerous other options may be permitted in the resource or resource group option 535 besides “the same site” such as a specific hospital, a specific room type, a specific specialty, etc. By using the selection rule “ALL,” the results of the selection rules below it must be qualified and must have a resource or resource group as specified. In FIG. 5, the results must ALL be from THE SAME SITE and if no resources satisfy these rules, then no results will be presented. A less restrictive rule such as “AS MANY AS POSSIBLE” must be from THE SAME SITE may present more results.

A second rule 540 may call for a rule 545 that “1” resource be chosen from the resource group “doctors” 550. A third rule 555 may call for a rule 560 that “1” “member” resource be chosen from the resource group “operating rooms” 565. A fourth rule 570 may call for a rule 575 that “2” “member” resource be chosen from the resource group “nurses” 580. More or less rules are acceptable as are other permutations of rules, resources and resource groups.

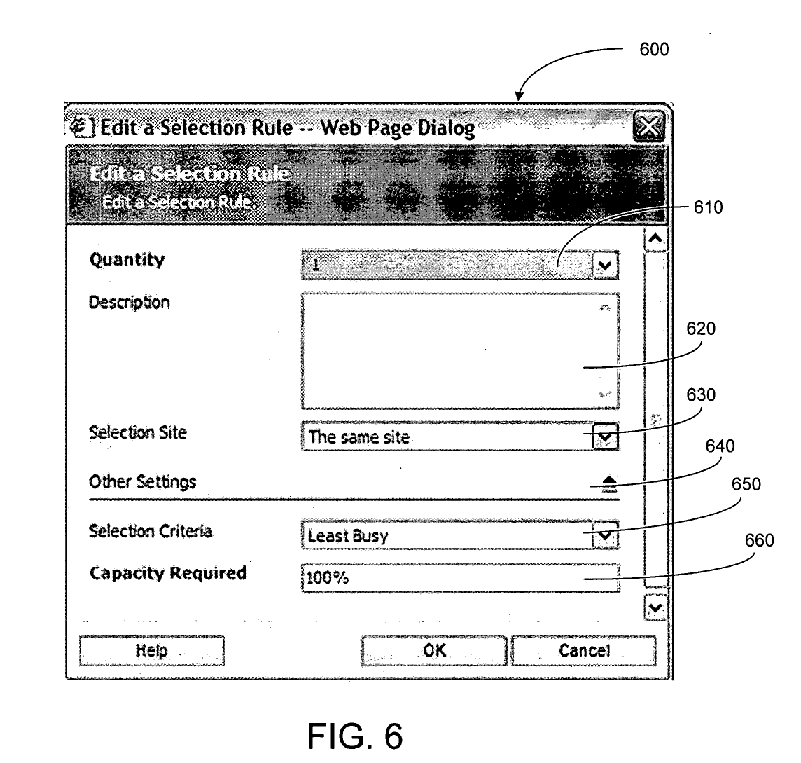

FIG. 6 may illustrate a display 600 of an allowing a selection rule to be edited. In this example, the quantity 610 may be modified by using a drop down box or typing in a new quantity. A description 620 may also be added. Options regarding the selection site 630 may be modified by making selections in a drop down box. Other settings 640 if available depending on the rule in question, may be modified. The selection criteria 650 may be modified along with the capacity required 660.

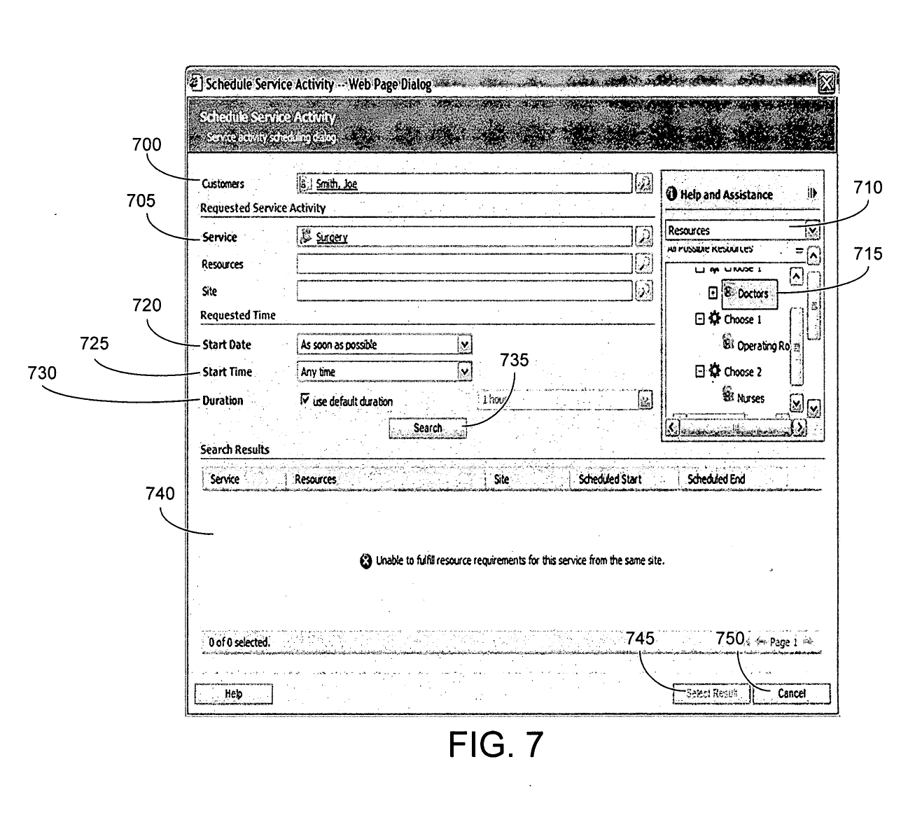

FIG. 7 may illustrate the results of the selections in FIG. 5. The service schedule may indicate the person or entity requiring the service 700 and the service may be specified 705 such that requests by the same entity for multiple services will not be confused. In a tab 710, a drop down box or other listing device may allow the review of the resources, resources groups, etc. selected in FIG. 6. In the example of FIG. 7, “resources” have been selected in the tab 710 to be reviewed and specifically, the resource “doctors” 715 has been selected to be reviewed. Certainly, other resources may be chosen to be reviewed. A requested time option may be displayed and modified. Box 720 may indicate the requested start time for the service, box 725 may indicate the desired start time for the service and box 730 may indicate the desired duration of the service. Any of these requested time options may be modified by using a drop down box or by typing in values. Once the requested time options are complete, selecting the search button 735 may result in the search results being displayed in box 740.

In FIG. 7, no options are displayed as matching the query. Logically, this makes sense because if there are no doctors, the service cannot proceed. Similarly, if there are no operating rooms, then the service cannot proceed. Further, the rule required that 1 doctor be selected and rules must be satisfied unlike functions which may be optimized but not necessarily met. In some cases, multiple options may be presented. One of the many options may be selected by clicking on the option with a mouse, for example, and the selected result may be scheduled by using the select result button 745. If none of the options are acceptable, the process may be canceled by selecting the cancel button 750.

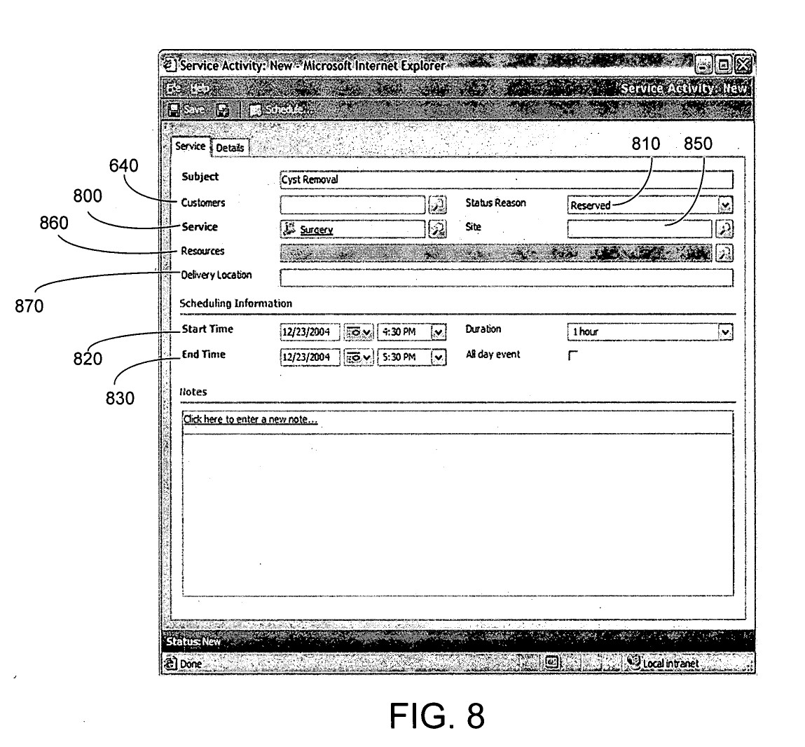

FIG. 8 may be an illustration of a search result from a search of FIG. 7 (assuming the search in FIG. 7 has some acceptable results.) The new service activity indicates that the service of surgery 800 is reserved 810 for a certain start time 820 and a certain end time 830. The service activity may also indicate the customer 840 requesting the service, the site or location of the service 850, the resources needed 860 and the delivery location 870. Further information on the service activity information may be obtained by selecting the displayed items.

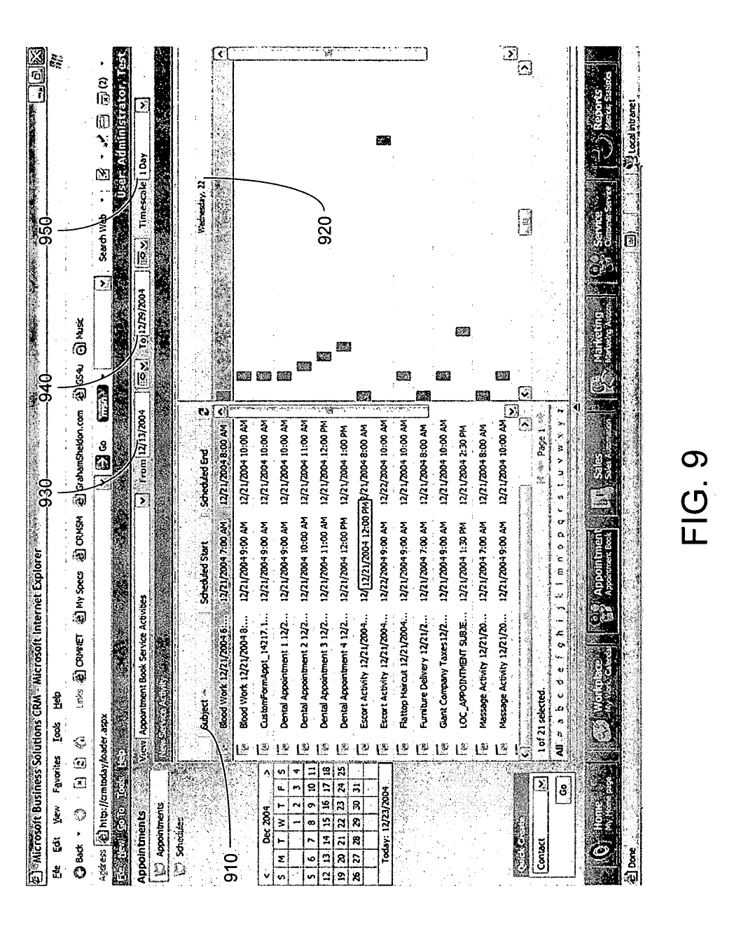

FIG. 9 may be an illustration of an appointment display in accordance with the claims. This display may be for a particular resource, such as a specific doctor. The appointments for a doctor may be displayed in a first box 910. These items can be scrolled through and additional detail may be obtained by selecting the appointment. A second box may display the blocks of time that a user may have available and the blocks that are unavailable. The time period for the display of appointments 910 may be adjusted by editing “from” 930 and “to” 940 input boxes and the time scale of the graphical display may edited in input box 950. A similar display may be created for service activities where a list of services to be performed is displayed. Using the installation of cable television example, the display may list the service calls that are to be performed during a given period, such as a day, where additional detail may be obtained by selecting a service call.

Although the forgoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

1. A method of scheduling comprising:
selecting a service for which a scheduling strategy is to be applied;
selecting the scheduling strategy to be applied to the service selected;
selecting an action to be applied to the selected service;
accessing a calendar related to the selected service;
in view of the service selected, allowing the constraints to be applied as required by the scheduling strategy; and
returning a result of applying the constraints.

2. The method of claim 1, wherein the action comprises at least one of the group of search, verify, book, query, reschedule and cancel.

3. The method of claim 1, further comprising allowing constraints and objective functions to vary depending on at least one of the group of the service selected and the scheduling strategy selected.

4. The method of claim 1, further comprising selecting at least one resource related to the service selected.

5. The method of claim 1, further comprising allowing different interpretations of one or more functions to be optimized and one or more constraints.

6. The method of claim 1, further comprising returning error information explaining why an action failed to produce expected results.

7. The method of claim 4, further comprising accessing a calendar related to the at least one selected resource.

8. A computer readable medium having computer executable instructions for performing scheduling comprising:
instructions for selecting a service for which a scheduling strategy is to be applied;
instructions for selecting the scheduling strategy to be applied to the service selected;
instructions for selecting an action to be applied to the selected service;
instructions for accessing a calendar related to the selected service;
in view of the service selected, instructions for allowing the constraints to be applied as required by the scheduling strategy;
allowing constraints and objective functions to vary depending on at least one of the group of the service selected and the scheduling strategy selected; and
instructions for returning a result of applying the constraints.

9. The computer readable medium of claim 8, wherein the action comprises at least one of the group of search, verify, book, query, reschedule and cancel.

10. The computer readable medium of claim 8, further comprising instructions for selecting at least one resource related to the service selected.

11. The computer readable medium of claim 8, further comprising instructions for allowing different interpretations of functions to be optimized and the constraints.

12. The computer readable medium of claim 8, further comprising instructions for allowing a weight to be applied to a function to be optimized when there are a plurality of functions.

13. The computer readable medium of claim 8, further comprising instructions for returning error information explaining why an action failed to produce expected results.

14. A computing apparatus, comprising:
a display unit that is capable of generating video images;
an input device;
a processing apparatus operatively coupled to said display unit and said input device, said processing apparatus comprising a processor and a memory operatively coupled to said processor,
a network interface connected to a network and to the processing apparatus;
said processing apparatus being programmed to:
select a service for which a scheduling strategy is to be applied;
select the scheduling strategy to be applied to the service selected;
select an action to be applied to the selected service;
access a calendar related to the selected service;
in view of the service selected, allow the constraints to be applied as required by the scheduling strategy; and
return a result of applying the constraints.

15. The computing apparatus of claim 14, wherein the action comprises at least one of the group of search, verify, book, query, reschedule and cancel.

16. The computing apparatus of claim 14, further comprising said processing apparatus being programmed to allow constraints and objective functions to vary depending on at least one of the group of the service selected and the scheduling strategy selected.

17. The computing apparatus of claim 14, further comprising said processing apparatus being programmed to select at least one resource related to the service selected.

18. The computing apparatus of claim 14, further comprising said processing apparatus being programmed to allow different interpretations of functions to be optimized and the constraints.

20. The computing apparatus of claim 14, further comprising said processing apparatus being programmed to return error information explaining why an action failed to produce expected results.
